(19) United States
(12) Patent Application Publication
(10) Pub. No.: US 2021/0253912 A1
(43) Pub. Date: Aug. 19, 2021

(54) MULTILAYER SELF-ADHESIVE FOULING RELEASE FILM WITH TEXTURED SURFACE

(71) Applicant: Avery Dennison Corporation, Glendale, CA (US)

(72) Inventors: Daniele PEROTTI, Dampremy (BE); Martine BOUVET, Le Roeulx (BE); Arjan LUGTHART, Almere (NL); Jacques M.L. COURTIN, Leiderdorp (NL); Kees VAN DER KOLK, Uitgeest (NL)

(21) Appl. No.: 17/272,461

(22) PCT Filed: Aug. 28, 2019
(86) PCT No.: PCT/EP2019/073011

§ 371 Date: Mar. 1, 2021

(30) Foreign Application Priority Data
Aug. 30, 2018 (EP) 18191834.3

(51) Int. Cl. C09J 7/29; B32B 7/06; B32B 7/12; B32B 27/32; B32B 3/30; B32B 27/36; B32B 38/06; B32B 37/24

(52) U.S. Cl. CPC C09J 7/29; C09J 2483/006; B32B 7/12; B32B 27/32; B32B 3/30; B32B 27/36; B32B 38/06; B32B 37/24; B32B 2255/24; B32B 2255/10; B32B 2037/243; B32B 2255/26; B32B 2405/00; B32B 2605/12; B32B 7/06

(57) ABSTRACT

The invention concerns a multilayer self-adhesive fouling release film with textured surface (1) provided with a surface morphology comprising a regular or randomly distributed pattern of ribs (3).

The invention also concerns a method for producing a multilayer self-adhesive fouling release film with textured surface (1) provided with a surface morphology comprising a regular or randomly distributed pattern of ribs (3), a use of the method for producing a multilayer self-adhesive fouling release film with textured surface (1) according to the invention and a method for producing a coated substrate.

### TECHNICAL FIELD

The present invention relates to a multilayer self-adhesive fouling release film with textured surface, and to a method for producing a multilayer self-adhesive fouling release film with textured surface.

### BACKGROUND

The presence of fouling on submerged structures can lead to a reduction in their performance, such as damage to static structures and underwater equipment or reduced speed and increased fuel consumption in ships. Fouling on submerged or underwater structures, such as a ship in contact with water, can be due to barnacles, mussels, moss animals, green algae, etc. Fouling on submerged or underwater structures is also known to lead to reduced maneuverability or to a reduction in thermal conductivity and is known to necessitate a cleaning operation which takes a lot of time and results in economic loss. Antifouling systems have been used to combat and/or prevent the detrimental effects of such fouling.

Self-adhesive fouling release films and methods for producing them are known from the prior art.

WO 2016/120255 A1 describes a multilayer self-adhesive fouling release coating composition comprising the following layers: (i) an optional removable underlying liner; (ii) an adhesive layer applied over and to the optional underlying liner when the latter is present; (iii)a synthetic material layer applied over and to the adhesive layer (ii); (iv) optionally, an intermediate silicone tie coat applied over and to the synthetic material layer (iii); (v) a silicone fouling release top coat applied over and to the synthetic material layer (iii), or, when present, over and to the intermediate silicone tie coat (iv); and optionally (vi) a removable polymeric film applied over and to the fouling release top coat (v). The multilayer self-adhesive fouling release coating composition according to WO 2016/120255 A1 can be directly applied on a substrate's surface, such as on the hull of a boat, in one single step, by simply pasting the self-adhesive composition on the surface to be coated, and thus avoiding the drawbacks of the fouling release compositions of the prior art requiring an application by spraying.

The multilayer self-adhesive fouling release coating composition according to WO 2016/120255 A1 could be further improved to ameliorate the fouling release effect. Besides, there is a general need for drag reduction for movable underwater structures such as ships, since this could lead to reduced fuel consumption and reduced greenhouse gas emissions.

### SUMMARY OF THE INVENTION

In a first aspect, the invention provides a multilayer self-adhesive fouling release film with textured surface, according to claim 1. In particular, the multilayer self-adhesive fouling release film with textured surface comprises:
(i) an optional removable underlying liner;
(ii) an adhesive layer, applied over and to the optional underlying liner (i) when present;
(iii) a synthetic material layer applied over and to the adhesive layer (ii);
(iv) optionally, an intermediate silicone tie coat which is a one component silicone system, a two components silicone system or a three components silicone system, applied over and to the synthetic material layer (iii);
(v) a silicone fouling release top coat comprising a silicone resin and one, two or more fouling release agents, applied over and to the synthetic material layer (iii), or, when present, over and to the intermediate silicone tie coat (iv); and optionally
(vi) a removable polymeric film applied over and to the fouling release top coat (v),

wherein a side (2) of the silicone fouling release top coat (v) facing away from the synthetic material layer (iii), or, when present, facing away from the intermediate silicone tie coat (iv), is provided with a surface morphology comprising a regular or randomly distributed pattern of ribs (3).

The ribs provide the silicone fouling release top coat with a textured surface morphology that impairs adherence of underwater organisms to the fouling release film, thus improving fouling release by the film and avoiding increased drag in time. At the same time, due to its structure, the textured surface morphology itself provides a drag reduction.

Ribs with different shapes are shown in FIGS. 5, 6 and 7. Rib shapes according to FIGS. 5, 6 and 7 have been found very suitable for fouling release and drag reduction purposes.

In a second aspect, the invention provides a method for producing a multilayer self-adhesive fouling release film with textured surface, according to claim 8. In particular, the method comprises the steps of:
a) providing an adhesive layer and, optionally, coating a removable underlying liner with the adhesive layer;
b) coating the adhesive layer with a synthetic material layer;
c) optionally, coating the synthetic material layer with an intermediate silicone tie coat which is a one component silicone system, a two components silicone system or a three components silicone system; and
d) coating the synthetic material layer, or, when present, the intermediate silicone tie coat with a silicone fouling release top coat comprising a silicone resin and one, two or more fouling release agents,

wherein at a semi-cured stage of the top coat, a removable polymeric film comprising an embossed surface is laminated onto a side of the silicone fouling release top coat facing away from the synthetic material layer, or, when present, facing away from the intermediate silicone tie coat, wherein said embossed surface of the removable polymeric film is a negative of a desired surface morphology of the top coat comprising a regular or randomly distributed pattern of ribs.

Using a removable polymeric film comprising an embossed surface for providing a surface morphology of the silicone fouling release top coat comprising ribs promotes a stable formation of said ribs while shielding the ribs from an environment until the multilayer film is prepared for use by removing the removable polymeric film. This ensures a well-defined formation of ribs and a highly textured surface morphology of the top coat which is beneficial for reasons of fouling release and drag reduction.

In a third aspect, the invention provides a use of a method according to the second aspect of the invention for the production of a multilayer self-adhesive fouling release film with textured surface according to the first aspect of the invention, according to claim 13.

In a fourth aspect, the invention provides a method for producing a coated substrate, comprising the step of coating at least part of an outer surface of the substrate with a multilayer self-adhesive fouling release film with textured surface according to the first aspect of the invention, according to claim 14.

### DESCRIPTION OF FIGURES

FIG. 1 is a schematic sectional view of a multilayer self-adhesive fouling release film with textured surface, according to embodiments of the invention.

FIG. 2 is a schematic sectional view of a synthetic material layer having functional groups on both its surfaces to increase the surface energy, according to embodiments of the invention.

FIG. 3 is a schematic sectional view of a part of a multilayer self-adhesive fouling film with textured surface which is ready to be applied on a substrate, according to embodiments of the invention.

FIG. 4 is a schematic sectional view of a part of a self-adhesive fouling release film which is wound after coating of an intermediate silicone tie coat, enabling the contact between a removable underlying liner and a silicone fouling release top coat, according to embodiments of the invention.

FIGS. 5, 6 and 7 are schematic details of the surface morphology of the silicone fouling release top coat, according to embodiments of the invention.

FIG. 8A is a schematic representation of steps for providing the silicone fouling release top coat with a surface morphology comprising ribs, according to embodiments of the invention.

FIGS. 8B and 8C are schematic representations of steps for providing the silicone fouling release top coat with a surface morphology comprising discrete protrusions, according to embodiments of the invention.

FIGS. 9-10 are schematic representations of the coating of a substrate with adjacent films with textured surface, according to embodiments of the invention.

### DETAILED DESCRIPTION OF THE INVENTION

As used herein, the expression “applied over and to” means that the layers are joined together, that is, are directly in contact with each other.

In a first aspect, the invention provides a multilayer self-adhesive fouling release film with textured surface comprising:
(i) an optional removable underlying liner;
(ii) an adhesive layer, applied over and to the optional underlying liner when present;
(iii) a synthetic material layer applied over and to the adhesive layer;
(iv) optionally, an intermediate silicone tie coat which is a one component silicone system, a two components silicone system or a three components silicone system, applied over and to the synthetic material layer;
(v) a silicone fouling release top coat comprising a silicone resin and one, two or more fouling release agents, applied over and to the synthetic material layer, or, when present, over and to the intermediate silicone tie coat; and optionally
(vi) a removable polymeric film applied over and to the fouling release top coat,

wherein a side of the silicone fouling release top coat facing away from the synthetic material layer, or, when present, facing away from the intermediate silicone tie coat, is provided with a surface morphology comprising a regular or randomly distributed pattern of ribs.

The ribs provide the silicone fouling release top coat with a textured surface morphology that impairs adherence of underwater organisms to the fouling release film, thus improving fouling release by the film and avoiding increased drag in time. At the same time, due to its structure, the textured surface morphology itself provides a drag reduction. The film according to the present invention is not to be regarded as obvious for a person skilled in the art, since such person would rather try to optimize the chemical composition of the layers of the multilayer film.

In a preferred embodiment the invention provides a film with textured surface according to the first aspect of the invention, wherein a rib has a height and wherein adjacent ribs are spaced from another according to a distance, and wherein the ratio of the distance between adjacent ribs and said rib height is from 3:1 to 1:1, and more preferably from 2.5:1 to 1.5:1 and even more preferably from 2.2:1 to 1.8:1.

Spacing between adjacent ribs is beneficial for drag reduction, and especially when valleys formed in spaces between adjacent ribs are generally parallel to a fluid flow. Said ratio of distance between adjacent ribs and rib height is found to be optimally suited for fouling release and drag reduction functionality of the film with textured surface according to the present invention.

In a preferred embodiment the invention provides a film with textured surface according to the first aspect of the invention, wherein a rib has a width and wherein rib width and rib height relate according to a ratio from 1:200 to 2:1 and more preferably from 1:50 to 1:1.

Ribs dimensioned with rib widths and heights that relate according to a ratio within said range are optimally suited to provide a silicone fouling release top coat with a highly textured surface morphology.

In a preferred embodiment the invention provides a film with textured surface according to the first aspect of the invention, wherein the height of a rib is from 20 to 200 μm, and more preferably from 23 to 180 μm and even more preferably from 25 to 160 μm.

Said rib heights are large enough to provide a sufficiently textured surface morphology for improving fouling release while the heights are not that large that the ribs themselves will cause a considerable drag increase of a substrate to be coated by a film with textured surface according to the invention, since a too large height of the ribs is negatively affecting the friction of the ribs with water.

In a preferred embodiment the invention provides a film with textured surface according to the first aspect of the invention, wherein the width of a rib is from 1 to 40 μm.

Such rib widths are large enough to structurally enable rib heights according to said ratio between rib width and rib height from 1:200 to 2:1. At the same time, the widths are not that large that the amount of ribs per surface area is reduced too much and/or that angles formed by the ribs are too large, resulting in suboptimal fouling release and drag reduction properties.

In a preferred embodiment the invention provides a film with textured surface according to the first aspect of the invention, wherein the distance between adjacent ribs is from 50 to 400 μm, more preferably from 55 to 350 μm and even more preferably from 60 to 310 μm.

Said distances between adjacent ribs are large enough to enable drag reduction while being not too large that the spaces between adjacent ribs would form large flat-bottomed valleys where underwater organisms might settle easily.

In a preferred embodiment the invention provides a film with textured surface according to the first aspect of the invention, wherein each rib shows an opening angle of 15 to 45°, more preferably of 20 to 40° and even more preferably of 25 to 35°.

Ribs with such opening angles are sharp and therefore beneficial for providing a sufficiently textured surface morphology. Smaller angles could pose problems regarding structural stability, which may negatively affect fouling release or drag reduction.

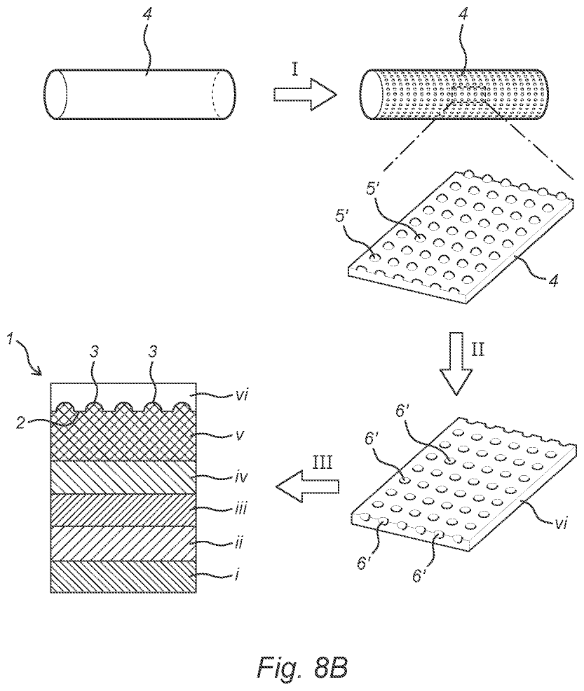

The width W, height H, opening angles α and distance between adjacent ribs D₁ as used herein are shown in FIGS. 5, 6 and 7. Each rib has a base, representing the collection of points in the plane of the surface which the rib protrudes. From the base emerges at least one side which converges into a top. The intersection of points between the base and the side(s) are the base angles. The plane where the rib protrudes the surface is the base plane. Each rib further has a top, the point or collection of points the furthest away from the base plane in which the base lies.

The distance between adjacent ribs D₁ is defined as the shortest distance between the base angles of two adjacent ribs. The top-to-top distance D₂ is defined as the shortest distance between the geometric center of the top of two adjacent ribs. E.g. for a flat top such as in FIG. 7, the geometric center (middle point) of each flat top is used.

The height of a rib is the distance between the base plane of said rib and the top of said rib. The width is the length of the shortest diameter connecting two base angles of said rib and crossing through the projection of the geometric center of the top onto the base plane.

The opening angle α of each rib is defined as the smallest angle that stretches in a plane perpendicular to the base plane, and that stretches from a base angle of the rib, to the top of said rib, to another base angle of said rib. If the top of a rib is a collection of points, then the geometric center of this collection of points is used.

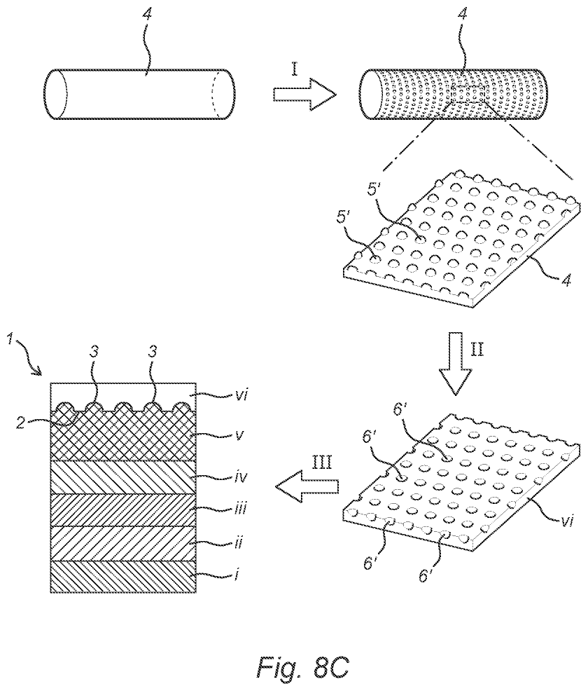

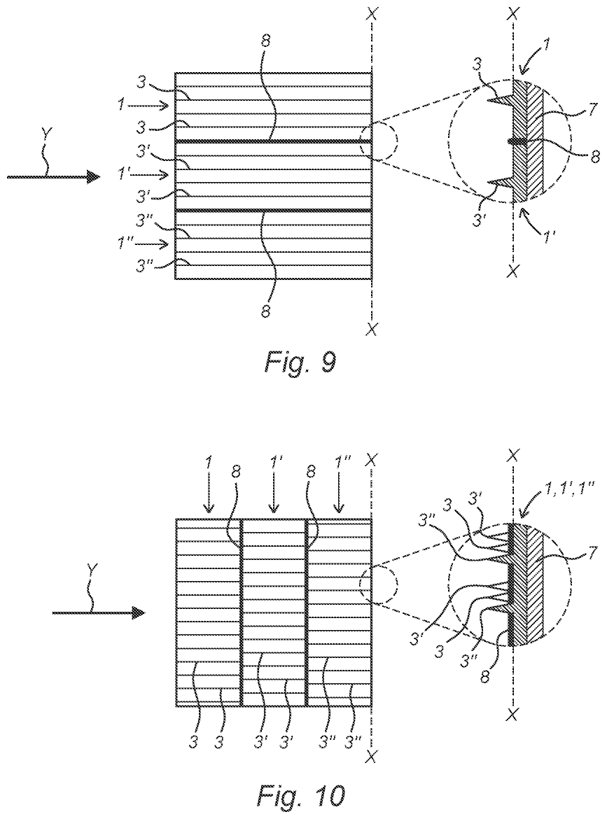

In an embodiment, the invention provides a film with textured surface according to the first aspect of the invention, wherein the ribs of the surface morphology are continuous. The terms “longitudinal ribs” and “continuous ribs” refer to ribs as shown in FIG. 8A.

In a preferred embodiment the invention provides a film with textured surface according to the first aspect of the invention, wherein the ribs of the surface morphology are discontinuous. That is to say that the textured surface is comprised of ribs, wherein each rib is comprised of a series of discrete protrusions or dots. The terms “discontinuous ribs” and “discrete protrusions” refer to ribs as shown in FIGS. 8B and 8C.

More preferably, these discrete protrusions are aligned. The inventors have surprisingly found that discrete protrusions can be beneficial for drag reduction. The drag may be reduced by entrapment of air in between said discrete protrusions. The drag may be reduced by optimization of the boundary layer along the surface. The drag may be reduced by improvement of the fouling release of the multilayered laminate. The drag may be reduced with respect to multidirectional fluid flows, changing fluid flow, unpredictable fluid flow or irregular fluid flow. For example, the drag reduction of ribs is optimized with regards to a particular fluid flow direction. The textured surface is optimized with respect to one optimal fluid flow. A different fluid flow at the surface can lead to a significant increase in frictional resistance. This can be alleviated by using ribs formed of discrete protrusions rather than longitudinal ribs. Discrete protrusions or dots can increase drag reduction and decrease frictional resistance, in particular when the fluid flow direction is variable, prone to change or unpredictable.

In a further embodiment, said discrete protrusions are each independently cone shaped, frustum shaped, rounded cone shaped, pyramid shaped, rounded pyramid shaped, dome shaped, half-spherical or irregular. The pyramid shapes can comprise any polygonal base, such as a triangle, quadrilateral, pentagon, hexagon, heptagon, octagon, nonagon, decagon and so forth. In a preferred embodiment the polygonal base is convex. In another preferred embodiment, the discrete protrusions have a convex top. In a preferred embodiment, the space between two discrete protrusions is concave. More preferably, the top of each protrusion is convex and the space between said adjacent protrusions is concave.

In another further preferred embodiment, said discrete protrusions are aligned. The aligned discrete protrusions advantageously can function similarly to continuous ribs in more than one direction. Planar aligned discrete protrusions can be represented as a lattice. Three-dimensional aligned discrete protrusions can be represented as a projection of a planar lattice on a three dimensional surface. The lattice can be represented by two base vectors. For the classification of a given lattice, start with one discrete protrusion and take a nearest second discrete protrusion. For a nearest third discrete protrusion, not on the same line, considering its distances to both discrete protrusion. Take the discrete protrusion wherein the smaller of these two distances is least. Among the discrete protrusions of which the smaller of these two distances is least, choose a discrete protrusion for which the larger of the two distances is also least. The result is a triangle. The two shortest sides of said triangle are considered the base vectors b₁ and b₂. Given any discrete dot, the other discrete dots can be found by linear combination of the base vectors b₁ and b₂.

There are five cases, corresponding to the triangle being isosceles, right, scalene, right isosceles and equilateral. An isosceles triangle corresponds to a rhombic lattice. A right triangle corresponds to a rectangular lattice. A scalene triangle corresponds to a parallelogrammic or oblique lattice. A right isosceles triangle corresponds to a square lattice. A equilateral triangle corresponds to a hexagonal or equilateral triangular lattice.

It should be noted that discrete protrusions are aligned along the base vector as well as the linear combinations of the base vectors b₁ and b₂. The discrete protrusions in a lattice are thus aligned along any vector v=x b₁+y b₂, wherein x and y are integers (positive and negative whole numbers including zero). For the present invention this is of particular importance for small integers. In the present text the alignment of discrete protrusions in a lattice is more narrowly defined as the direction of the vectors v=x b₁+y b₂, wherein x and y are both chosen independently from the list of −1, 0 and 1. A textured surface comprising longitudinal continuous ribs will be optimized for fluid flow going back and forth along one fluid flow direction, for example along the direction of the longitudinal continuous ribs (which can be seen as angles of 0° and 180°). A textured surface comprising aligned discrete protrusions can be aligned along several directions. The textured surface can thus be optimized for fluid flow going back and forth along more than one direction. This is advantageous if fluid flow is expected to change directions and allows optimization of the surface texture along multiple fluid flow directions. Furthermore this can be advantageous to minimize the effects of irregular fluid flow, turbulent fluid flow, unpredictable fluid flow directions or changing fluid flow directions.

In a further preferred embodiment, the two base vectors make an angle of 90°. This type of lattice is also called “rectangular” herein. In a further preferred embodiment, the discrete protrusions form a square lattice. A square lattice shows 90° rotational symmetry or 4-fold symmetry. That is to say, the discrete protrusions are aligned along the base vector in 4 directions due to said 4-fold symmetry; and aligned along the bisector of the base vectors in 4 directions due to said 4-fold symmetry. For a square lattice discrete protrusions are aligned back and forth along the base vectors (which can be seen as angles of 0°, 90°, 180° and 270°) as well as back and forth along the bisectors of the base vectors (which can be seen as angles of 45°, 135°, 225°, 315°). From this embodiment it is clear that aligned discrete protrusions can be aligned along significantly more directions than longitudinal continuous ribs. The alignment of discrete protrusions along a base vector of a square lattice in shown in FIG. 8B.

In a different, further preferred embodiment, the discrete protrusions form a rhombic lattice. In a different, further preferred embodiment, the discrete protrusions form an oblique lattice. The alignment of discrete protrusions along a bisector of the base vectors of an oblique lattice is shown in FIG. 8C. A rhombic lattice advantageously allows optimization between the angles wherein the discrete protrusions are aligned.

In a different further preferred embodiment, two base vectors make an angle of 60° and are equidistant. The lattice shows a 60° rotational symmetry or 6-fold symmetry. This type of lattice is also called “hexagonal” herein. In a hexagonal lattice the discrete protrusions are aligned along the base vector in 6 directions (which can be seen as angles of k*60°, wherein k is chosen from 0 to 5) due to said 6-fold symmetry; and aligned along the bisector of the base vectors (which can be seen as angles of 30°+k*60, wherein k is chosen from 0 to 5) in 6 directions due to said 6-fold symmetry. The discrete protrusions are thus aligned along 12 directions. This is advantageous if fluid flow direction is expected to make only small angular deviations (e.g. 30°) from the optimal fluid flow direction, or if the flow is very unpredictable, irregular or changing frequently.

In a preferred embodiment the invention provides a film with textured surface according to the first aspect of the invention, wherein a rib is comprised of aligned discrete protrusions, wherein the spacing between two discrete protrusions and the height of said discrete protrusions relate according to a ratio from 1:200 to 2:1 and more preferably from 1:50 to 1:1.

The spacing between aligned discrete protrusions should be measured as the length of the base vectors. The base vectors should be chosen as to minimize their length and being linearly independent.

In a preferred embodiment the invention provides a film with textured surface according to the first aspect of the invention, wherein a rib is comprised of aligned discrete protrusions, wherein the height of a discrete protrusion is from 20 to 200 μm, and more preferably from 23 to 180 μm and even more preferably from 25 to 160 μm.

Said discrete protrusion heights are large enough to provide a sufficiently textured surface morphology for improving fouling release while the heights are not that large that the discrete protrusions themselves will cause a considerable drag increase of a substrate to be coated by a film with textured surface according to the invention, since a too large height of the discrete protrusions negatively affects the friction of the discrete protrusions with water.

In a preferred embodiment the invention provides a film with textured surface according to the first aspect of the invention, wherein the distance between two discrete protrusions is from 1 to 40 μm.

Such distances between discrete protrusions are large enough to structurally enable discrete protrusion heights according to said ratio between rib width and rib height from 1:200 to 2:1. At the same time, the distances are not that large that the amount of discrete protrusions per surface area is reduced too much and/or that discrete protrusions formed by the ribs are too large, resulting in suboptimal fouling release and drag reduction properties.

In a preferred embodiment the invention provides a film with textured surface according to the first aspect of the invention, wherein a rib is comprised of aligned discrete protrusions, wherein the distance between adjacent ribs is from 50 to 400 μm, more preferably from 55 to 350 μm and even more preferably from 60 to 310 μm.

In an embodiment, adjacent discrete protrusions have different sizes, shapes or orientations. In another embodiment, longitudinal ribs may be adjacent to discrete protrusions or dots. In another embodiment, longitudinal ribs may be discontinued into discrete protrusions. That is to say at least one longitudinal rib is aligned with discrete protrusions on one line.

In a preferred embodiment the invention provides a film with textured surface according to the first aspect of the invention, wherein the film with textured surface is wound into a roll for storage purposes.

In embodiments, the thickness of the multilayer self-adhesive fouling release film with textured surface of the present invention depends on the thickness of each layer in the film provided that properties claimed in the present invention are not affected. In preferred embodiments, the thickness of the multilayer self-adhesive fouling release film with textured surface is from 50 μm to 5000 μm, more preferably from 100 μm to 2000 μm, and even more preferably from 200 μm to 700 μm.

In preferred embodiments, the strength of adhesion of aquatic organisms onto an applied multilayer self-adhesive fouling release film with textured surface of the present invention is 0.1 N/mm² or less, more preferably 0.01 N/mm² or less, still more preferably 0.002 N/mm² or less. The lower the strength of adhesion is between the fouling release top coat and an aquatic organism, the more efficient is the film in terms of fouling release properties. The low strength of adhesion may also be beneficial to low drag properties.

The strength of adhesion of aquatic organism onto an applied self-adhesive fouling release film with textured surface may be measured with a dynamometer such as an ADEMVA DM10. The method may be as follows: apply a pressure on the aquatic organism to release it from the fouling release top coat of an applied multilayer self-adhesive fouling release film with textured surface.

In preferred embodiments, the multilayer self-adhesive fouling release film with textured surface is flexible enough to allow a good conformation to all irregular shapes of the underwater structure to wrap. The flexibility may be measured by testing the tensile strength of the film at 10% elongation, according to the norm ISO 527-3/2/300. The tensile strength at 10% elongation at 23° C. is preferably 15 N/15 mm or less. When the tensile strength at 10% elongation is within one of these ranges, the film can be applied with satisfaction on the shapes of a substrate such as an underwater structure. A high tensile strength at 10% elongation, being outside the above ranges, of the multilayer self-adhesive fouling release film with textured surface may cause some lifting from the irregular underwater structure, and is therefore undesired.

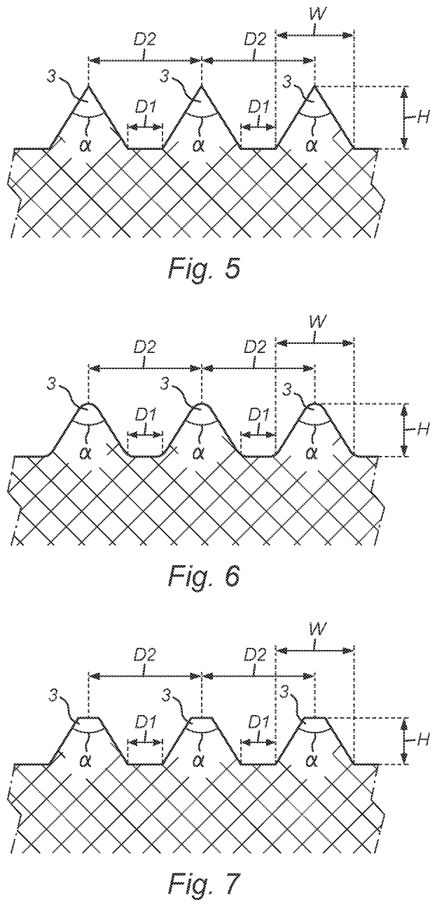

The elongation at break of the multilayer self-adhesive fouling release film with textured surface depends on the elongation of each layer illustrated in FIG. 3. The elongation at break of the multilayer self-adhesive fouling release film is measured according to the norm ISO 527-3/2/300. The elongation at break at 23° C. is preferably 15% or more, more preferably 50% or more. When the elongation at break is in the range, the film can be applied with satisfaction on the shapes of the underwater structure and give a good re-workability during the time of application. If the elongation at break is less than 15% of elongation, the working efficiency could be reduced because of the low elongation and breaking of the multilayer film with textured surface.

The tensile strength at break of the multilayer self-adhesive fouling release film with textured surface depends on the elongation of each of the layers illustrated in FIG. 3. The tensile strength at break of the multilayer self-adhesive fouling release film is measured according to the norm ISO 527-3/2/300. In preferred embodiments, the tensile strength at break at 23° C. is 10 N/15 mm or more and more preferably 20 N/15 mm or more. The more the tensile strength at break is in the range, the more the film can be applied with satisfaction on the shapes of the underwater structure and give a good re-workability during the time of application. If the tensile strength at break is less than 10 N/15 mm, the working efficiency could be reduced because of the fast breaking of the film, and is therefore undesired.

In preferred embodiments, the 180° peeling strength of adhesion of the multilayer self-adhesive fouling release film with textured surface at a speed of 300 mm/min between the adhesive layer (ii) and the underwater structure, as measured according to the Finat test method FTM 1 at 23° C., is 10 N/25 mm or more, more preferably 25 N/25 mm or more and still more preferably 40 N/25 mm or more. The higher the peeling strength is the lower is the risk to have self-lifting from a substrate coated with the film with textured surface according to the first aspect of the invention.

In a second aspect, the invention provides a method for producing a multilayer self-adhesive fouling release film with textured surface, the steps of:
a) providing an adhesive layer and, optionally, coating a removable underlying liner with the adhesive layer;
b) coating the adhesive layer with a synthetic material layer;
c) optionally, coating the synthetic material layer with an intermediate silicone tie coat which is a one component silicone system, a two components silicone system or a three components silicone system; and
d) coating the synthetic material layer, or, when present, the intermediate silicone tie coat with a silicone fouling release top coat comprising a silicone resin and one, two or more fouling release agents,

wherein at a semi-cured stage of the top coat, a removable polymeric film comprising an embossed surface is laminated onto a side of the silicone fouling release top coat facing away from the synthetic material layer, or, when present, facing away from the intermediate silicone tie coat, wherein said embossed surface of the removable polymeric film is a negative of a desired surface morphology of the top coat comprising a regular or randomly distributed pattern of ribs.

Using a removable polymeric film comprising an embossed surface for providing a surface morphology of the silicone fouling release top coat comprising ribs promotes a stable formation of said ribs while shielding the ribs from an environment until the multilayer film is prepared for use by removing the removable polymeric film. This ensures a well-defined formation of ribs and a highly textured surface morphology of the top coat which is beneficial for reasons of fouling release and drag reduction.

In a preferred embodiment the invention provides a method according to the second aspect of the invention, wherein said removable polymeric film is a polypropylene or polyester film.

A polypropylene or polyester film can be provided with an embossed surface without breaking and also avoids transfer of silicone from the silicone fouling release top coat during curing of the top coat.

In a preferred embodiment the invention provides a method according to the second aspect of the invention, wherein prior to laminating onto said side of the silicone fouling release top coat, embossing of the removable polymeric film resulting in said embossed surface is performed by a textured rod which is pressed against the film. A textured rod enables embossing of the removable polymeric film over a large area of polymeric film and within a limited amount of time.

In a preferred embodiment the invention provides a method according to the second aspect of the invention, wherein during embossing of the removable polymeric film, said textured rod is pressed against the film at an embossing pressure from 4 to 8 MPa. Said pressure levels are optimally suited to emboss said removable polymeric film.

In a preferred embodiment the invention provides a method according to the second aspect of the invention, wherein said textured rod has a cylindrical shape. Such cylindrically shaped rod shows the advantage that the rod can be rolled while being pressed against the film, speeding up the embossing and also avoiding any irregularities in embossing due to corners, which could be encountered when using other rods, such as, for example, a rectangular rod.

In a third aspect, the invention provides a use of a method according to the second aspect of the invention for the production of a multilayer self-adhesive fouling release film with textured surface according to the first aspect of the invention.

Accordingly, all technical achievements and positive features of the method according to the second aspect of the present invention are combined with those of the film with textured surface according to the first aspect of the present invention.

In a fourth aspect, the invention provides a method for producing a coated substrate, comprising the step of coating at least part of an outer surface of the substrate with a multilayer self-adhesive fouling release film with textured surface according to the first aspect of the invention.

In a preferred embodiment the invention provides a method according to the fourth aspect of the invention, wherein the film with textured surface and/or the substrate are heated prior to and/or during the coating step. Heating activates adhesive present in the adhesive layer, thus promoting the adhesion between film with textured surface and substrate.

In a preferred embodiment, the removable underlying liner is removed prior to application of the multilayer film on a substrate's surface.

In a preferred embodiment, the removable polymeric film is removed once the multilayer film has been applied on a substrate's surface.

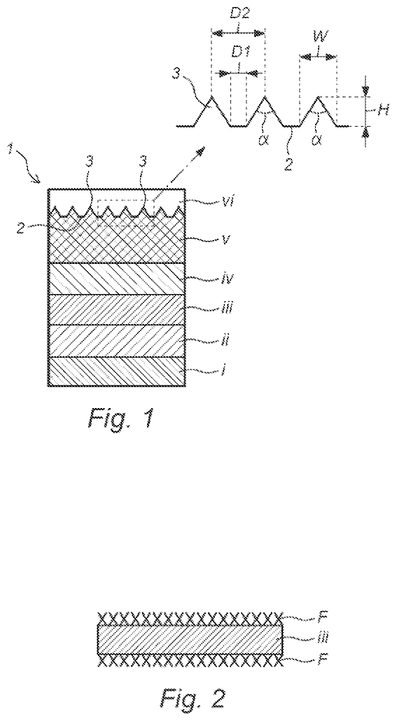

A multilayer self-adhesive fouling release film with textured surface according to a preferred embodiment of the present invention is composed as illustrated in FIG. 1. According to a preferred embodiment of the present invention, the term “applied multilayer self-adhesive fouling release film with texture surface” is used to indicate the multilayer self-adhesive fouling release film with texture surface as if ready to be applied or coated on a substrate, such as an underwater structure, or when it has been applied or coated on a substrate. An “applied multilayer self-adhesive fouling release film with textured surface” thus comprises a layered structure as schematically shown in FIG. 3: the applied film with textured surface comprises fewer layers, since the removable underlying liner is removed prior to application of the multilayer film on a substrate's surface and the removable polymeric film is removed once the multilayer film has been applied over a surface to be coated.

In the following, embodiments are described of the different layers of the film with textured surface according to the invention.

Removable Underlying Liner

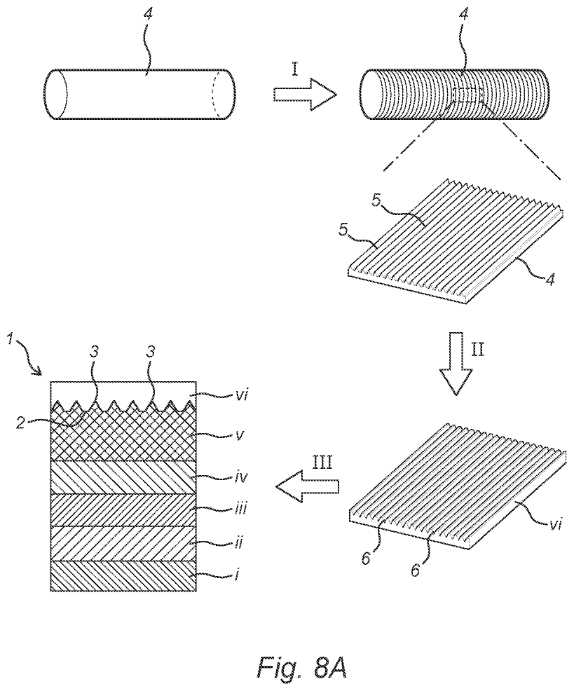

The removable underlying liner is removed prior to application of the multilayer film on a substrate's surface. In a preferred embodiment, the removable liner is present. In preferred embodiments, the removable liner is a siliconized paper or siliconized synthetic layer. In embodiments wherein the removable polymeric film layer is not comprised in the multilayer self-adhesive fouling release film with textured surface according to the invention, as in the embodiments shown in FIG. 3 and FIG. 4, the removable liner can exert two functional roles: 1) the role of a liner for the adhesive layer and 2) when the multilayer self-adhesive fouling release film with textured surface is wound into a roll, the role of a protective material for the silicone tie coat or the silicone fouling release top coat.

In preferred embodiments, such removable liner is preferably a clay coated backing paper coated by an addition-type siliconized system. The clay coated paper contains a humidity rate preferably 3% and more, more preferably from 6% to 10% by weight of water. The humidity, contained in the paper, participates to the hydrolysis of the acetate ion, CH3COO—, which is a product formed during curing of the tie coat. The acetate ion has to be destroyed during the process; the humidity contained in the liner participating in this hydrolysis of the acetate ion. The property of the clay coated removable liner is important as it is well-known that the kinetic and the post curing of the last deposit comprising the fouling release top coat is affected by the presence of the acetate ion. Now, it has been observed that the humidified paper liner reduces the amount of residual acetic acid in the tie coat and thus advantageously enables to restore a good curing kinetic of the fouling release top coat. Indeed, in preferred embodiments, during curing of the tie coat, the film comprising layers shown in FIG. 4 is wound into a roll so that layer (iv) comes into contact with layer (i) which may reduce the amount of acetate. When the roll is unwound, the fouling release top coat (v) may be coated on the tie coat layer (iv) which has a reduced amount of acetic acid. When a siliconized synthetic or polyethylene paper is used as removable liner, the acetate ion is not hydrolyzed when the film illustrated in FIG. 4 is wound into a roll, which will slow down curing of the fouling release top coat (v) which is not dry after the process step and may give some variations of thickness of the fouling release top coat (v) by deepness in the roll.

In preferred embodiments, the weight of the removable liner is 15 g/m² or more, more preferably 25 g/m² or more and even more preferably from 40 to 165 g/m². When the weight is within the range, the removability of the removable liner from the adhesive layer is satisfactory and enables a good working efficiency. When the weight is lower than 15 g/m², it becomes difficult to remove it, because of tearing of the removable liner, which may result in some parts of the liner that stay on the adhesive layer.

In preferred embodiments, the strength of adhesion of the removable liner between the removable liner and the adhesive layer is 150 g/25 mm or less, more preferably 80 g/25 mm or less and even more preferably 60 g/25 mm or less. When the strength of adhesion is within the range, the removability of the removable liner from the adhesive layer is satisfactory and enables a good working efficiency. When the strength of adhesion is higher than 150 g/25 mm, it becomes difficult to remove it because of tearing of the removable liner, which may result in some parts of the liner that stay on the adhesive layer.

Adhesive Layer

The adhesive layer (ii) is capable of securing the multilayer self-adhesive fouling release film with textured surface to a desired location. Conventional adhesives include notably pressure sensitive adhesives (PSA).

The pressure sensitive adhesives (PSA) can be any pressure sensitive adhesive having at least the following characteristics: (a) is capable of creating lasting adhesion to the material to be coated, such as the ship hull material, and the synthetic material layer of the present invention, for at least five years; (b) is resistant to marine conditions.

In a preferred embodiment, a PSA for the adhesive layer (ii) is defined to ensure the optimal properties for the present invention. The material used for such application could be for example acrylic PSA resin, epoxy PSA resin, amino based PSA resin, vinyl based PSA, silicone based PSA resin, a rubber-based adhesive, etc. In preferred embodiments, the PSA is a solvent based acrylic adhesive, more preferably a solvent based acrylic adhesive resistant to water and allowing an application at low temperatures from −10° C. to 60° C. and more preferably from 3° C. to 30° C. This characteristic should permit an application during all the year.

PSA based on acrylic acid polymers, notably comprising an acrylic polymer and a cross-linking agent are particularly suitable. Examples of such acrylic polymers are polymers formed from monomeric acrylic acid and/or an acrylic ester. A cross-linking agent starts the polymerization by forming free radicals which attack the double bonds in said monomeric acrylic acid and/or acrylic acid compounds. The polymerization is stopped either by an inhibitor or by a recombination of radicals. A suitable cross-linking agent includes an isocyanate crosslinker. In other embodiments, the cross-linking agent includes a metal organic curing agent, an isocyanate curing agent or others.

Example of metal curing agent:

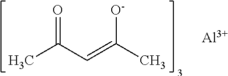

Examples of the crosslinking process of the adhesive used for the pressure sensitive fouling release.

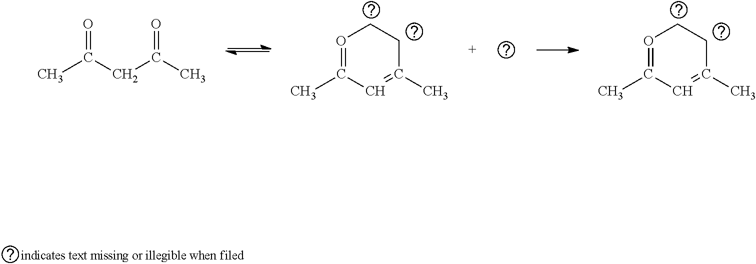

The outer surface of the adhesive layer may be covered with a removable liner which is released prior to application.

In preferred embodiments, the layer will generally have a thickness between 5 μm and 250 μm, and more preferably between 60 μm and 150 μm depending on the type of adhesive used and the application envisaged.

Synthetic Material Layer

A layer of synthetic material, or synthetic material layer, allowing to coat an optional tie coat layer on one side, and the adhesive layer on the other side. The synthetic material has preferably excellent properties of impermeability, water resistance, flexibility and elongation. In preferred embodiments, the polymeric material for the synthetic material layer includes polyvinylchloride, a vinylchloride resin, a polyvinylchloride resin, a polyurethane resin, a polyurethane acrylic resin, a vinyl chloride resin, a rubber-based resin, a polyester resin, a silicone resin, an elastomer resin, a fluoro resin, nylon, a polyamide resin and/or a polyolefin resin, such as polypropylene and polyethylene. Such materials for the synthetic material layer may be present in one sub-layer or may be present in two sub-layers or more. The nature and components of each of said sub-layers can bring additional anchorage and barrier properties to the synthetic material layer.

When the synthetic material layer contains an elastomer, the elastomer is preferably an olefin-based elastomer. In preferred embodiments, the olefin-based elastomer is a polypropylene-based elastomer. In preferred embodiments, said polypropylene-based elastomer is selected from the group comprising no-oriented polypropylene, bi-oriented polypropylene and blow polypropylene, or any combination thereof. It is well-known that elastomers possess the mechanical property to undergo elastic deformation under stress with the material returning to its previous size without permanent deformation. The use of an olefin-based elastomer can thus provide a multilayer self-adhesive fouling release film with textured surface that can be applied on a flat and curved surface with good workability without wrinkles formation. Said polypropylene-based elastomer further allows a good anchorage on the adhesive layer, the optional tie coat and, when the optional tie coat is not present, on the top coat. By good anchorage of layers is meant that the adhesive layer and the synthetic material layer, the synthetic material layer and the tie coat and, when the optional tie coat is not present, the synthetic material layer and top coat do not split up during the period and under the conditions of intended product use.

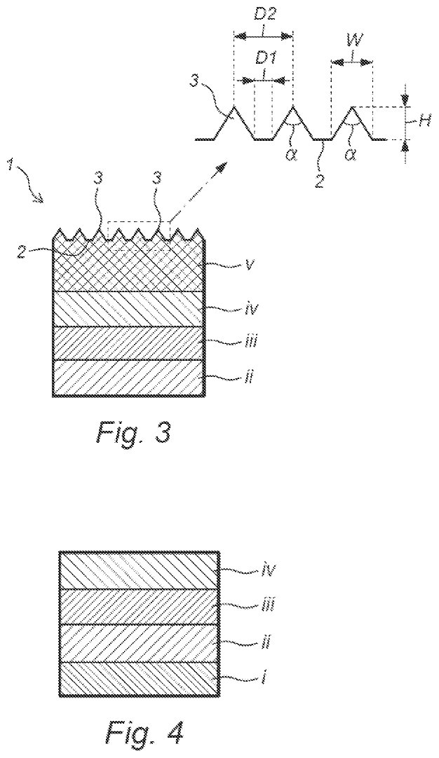

In preferred embodiments, to further ameliorate the anchorage of said synthetic material layer, the synthetic material layer is treated on one or both of its sides. In preferred embodiments, said synthetic material layer is treated on one or both of its sides, preferably on both of its sides, using a corona treatment or a plasma treatment, resulting in epoxy functional groups, acrylic functional groups, carboxylic functional groups, amino functional groups, urethane functional groups, and/or silicone functional groups on the surface of the synthetic material layer. In other preferred embodiments, said synthetic material layer is treated on one or both of its sides, preferably on both of its sides, by using a primer treatment. In preferred embodiments, the synthetic material layer comprises a polypropylene-based elastomer and is treated on one or both of its sides, preferably on both of its sides, with a plasma treatment using a N₂ gas, providing amide, amine and imide functional groups on one or both of the sides, preferably on both sides, of said layer. A schematic sectional view of an embodiment wherein the synthetic material layer (iii) is provided with functional groups (represented as F) on both of its sides or surfaces, in order to increase the surface energy, is shown in FIG. 2.

If the synthetic material layer is porous to any component which could migrate and modify the original properties of the film, it could be necessary to adjust the synthetic material layer thickness and/or add a barrier layer in the synthetic material layer or to its surface. The thickness of synthetic material depends on the nature of the synthetic material layer provided that the properties of the present invention are not deteriorated. In preferred embodiments, the thickness of the synthetic material layer is from 10 μm to 3000 μm, more preferably from 30 μm to 1000 μm and even more preferably from 50 μm to 300 μm. When the thickness is too low, the migration from any component coming from optional layer or layer, or a water molecule, may go through the synthetic material layer and modify the original properties of the film.

Intermediate Silicone Tie Coat

The optional intermediate silicone tie coat layer may be used as a bond between the synthetic material layer and the fouling release top coat. In preferred embodiments, the tie coat layer is a one component silicone system, a two components silicone system or a three components silicone system. The two latter systems are curable by an addition-type or condensation-type curing system. The composition of the tie coat layer is preferably a two components polysiloxane or a silane silicone curable by a poly-condensation system which means that the polysiloxane or silane contains reactive groups which enable curing. In preferred embodiments, the tie coat layer is an organo functional silane having the following chemical structure:

X—CH₂CH₂CH₂Si(OR)₃₋ₙR′ₙ where n=0, 1, 2

The OR groups are hydrolysable groups such as, preferably, methoxy, ethoxy or acetoxy groups and more preferably acetoxy groups. The group X is preferably an organo functional group such as epoxy, amino, methacryloxy or sulfide groups, more preferably organo functional groups with the addition of an acid or an organic acid. The acid can preferably be a carboxylic acid, particularly preferably acetic acid. The addition of acid greatly increases the adhesion of a silicone elastomer as fouling release top coat.

In preferred embodiments, the thickness of the tie coat layer is preferably from 10 μm to 120 μm, more preferably from 20 μm to 80 μm and still more preferably from 30 μm to 60 μm. When the value is within the range, the tie coat layer is dry after a heating step during a process for the manufacture of the film, for example, when it leaves an oven during such manufacturing process, and has a good anchorage on the synthetic material layer. It also enables to have a satisfactory anchorage of the fouling release top coat which is coated on the tie coat layer. When the thickness is higher than 120 μm, the tie coat is not dry after a heating step and the consequence is that it sticks on the removable liner when the film illustrated in FIG. 4 is wound, and then the next step, which is the coating of the fouling release top coat, cannot be done. When the thickness is lower than 20 μm, the combination of tie coat layer and fouling release top coat may be removed from the multilayer self-adhesive fouling release film with textured surface, resulting in loss of the fouling release properties.

Silicone Fouling Release Top Coat

In preferred embodiments, the silicone fouling release top coat comprises a silicone resin. The number of kinds of silicone resins may be only one or two or more. Such silicone resin may be a condensation-type silicone resin or may be an addition-type silicone resin. In addition, the silicone resin may be a one-component silicone resin to be dried alone or a two-components silicone resin to be compounded with a curing agent. The silicone resin is preferably an elastomer silicone resin, more preferably a polysiloxane containing reactive groups which can react with a curing agent by a condensation-type reaction. This kind of silicone system gives good properties of low surface energy. Examples of polysiloxane are polydialkylsiloxane, polydiarylsiloxane or polyalkylarylsiloxane typically of the formula:

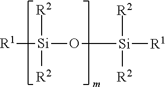

wherein each R¹ is independently selected from —H, —Cl, —F, C1-4-alkyl (e.g. —CH₃, —CH₂CH₃, —CH₂CH₂CH₃, —CH(CH₃)₂, —CH₂CH₂CH₂CH₃), phenyl (—C₆H₅), and C1-4-alkylcarbonyl (e.g. —C(═O)CH₃, —C(═O)CH₂CH₃ and —C(═O)CH₂CH₂CH₃), in particular —H and methyl; wherein R² is independently selected from C1-10-alkyl (including linear or branched hydrocarbon groups) and aryl (e.g. phenyl (—C₆H₅)), in particular methyl, and wherein m is 0-5000.

In preferred embodiments, the fouling release top coat contains a fouling release agent. Any appropriate fouling release agent may be used as fouling release agent as far as the fouling release effect is not damaged. Examples of such fouling release agents include, but are not limited to, silicone oil, liquid paraffin, surfactant wax, petrolatum, animal fats and fatty acid. The number of different kinds of fouling release agent may be one, two or more. When the fouling release top coat contains a fouling release agent, the surface energy of the fouling release top coat is lower and the multilayer self-adhesive fouling release film with textured surface maintains a good fouling release property for a long time period. This fouling release agent migrates to the surface of the silicone resin as matrix and covers the surface of the fouling release top coat with the fouling release component to reduce and prevent the fouling on an underwater structure by reducing the surface energy. The fouling release agent is preferably a silicone oil, more preferably a non-hydrolysable silicone oil and is preferably free of reactivity with the silicone resin. In a preferred embodiment, the silicone fouling release top coat comprises a non-hydrolysable silicone oil which is free of reactivity with the silicone of said fouling release top coat. The latter composition of the top coat is especially preferred since it allows for the fouling release effect to be maintained for a long time period. Said silicone oil is preferably composed by a homopolymer siloxane oil or a copolymer siloxane oil, such as a phenyl-methyl dimethyl siloxane copolymer and phenyl-methyl siloxane homopolymer.

In preferred embodiments, the amount of silicone oil present in the fouling release layer is from 0.1 to 100% dry weight, more preferably from 1 to 99.99% dry weight and still more preferably from 2 to 50% dry weight. When the value is within the range, the multilayer self-adhesive fouling release film with textured surface has good fouling release properties to reduce and prevent the fouling on an underwater structure. When the value is lower than 0.1% dry weight, the fouling release property is not achieved and the amount of fouling cannot be reduced or prevented on an underwater structure. When the value is higher, the silicone oil is released from the multilayer self-adhesive fouling release film with textured surface and may cause a problem for the anchorage of the fouling release top coat on the tie coat layer or the synthetic material layer.

In preferred embodiments, the thickness of the fouling release top coat is from 80 μm to 800 μm, more preferably from 120 to 300 μm and still more preferably from 180 to 250 μm. When the value is within the range, the fouling release top coat is dry after a heating step during a process for the manufacture of the film, for example, when it leaves an oven during such manufacturing process, and has fouling release properties to reduce and prevent the apparition of aquatic organisms on an underwater structure. When the thickness is lower than 80 μm, the fouling release property may not be sufficient to reduce and prevent the apparition of aquatic organisms on and underwater structure, which will increase the water friction and reduce the speed and maneuverability of said underwater structure.

Removable Polymeric Film

The removable polymeric film is to be removed notably once the adhesive layer of the multilayer film has been applied over a substrate to be coated. In a preferred embodiment, the removable polymeric film is present in the multilayer film according to the first aspect of the present invention.

In preferred embodiments, the removable polymeric film is a polyester or a polypropylene film. Said film advantageously prevents the migration of silicone and/or exuding liquid up to the adhesive layer when the film comprising all six layers is wound into a roll, wherein the top coat layer would come into contact with the underlying liner when the tie coat would be absent. This is likewise the case when the film comprising adhesive layer, synthetic material layer, optionally tie coat, top coat and removable polymeric film is wound into a roll, wherein the top coat would come directly into contact with the adhesive layer when the removable polymeric film would be absent. In other embodiments, the removable polymeric film comprises polyvinylidene fluoride, polyurethane, polyvinylchloride or another material.

The removable polymeric film has possibly one function or more, preferably two functions or more. One function could be the protection of the top coat from scratch and scuff during the manipulation and the application. The removable polymeric film of the multilayer self-adhesive fouling release film with textured surface has to be removed just after the adhesive layer of the multilayer film has been applied over the surface to be coated.

A second function may be, when the multilayer self-adhesive fouling release film is wound into a roll, to prevent the migration of components from the tie coat and top coat layers through the removable underlying liner which could modify the original properties of the multilayer film.

The invention is further described by the following non-limiting examples which further illustrate the invention, and are not intended to, nor should be interpreted to limit the scope of the invention.

### EXAMPLES

### Examples 1-12

FIGS. 1-5 and 8 illustrate a preferred embodiment of a multilayer self-adhesive fouling release film with textured surface according to the first aspect of the invention, and a use of a preferred embodiment of a method according to the second aspect of the invention for producing said film with textured surface.

FIG. 1 shows an example of a multilayer self-adhesive fouling release film with textured surface 1 comprising:
(i) a removable underlying liner;
(ii) an adhesive layer, applied over and to the underlying liner i;
(iii) a synthetic material layer applied over and to the adhesive layer ii;
(iv) an intermediate silicone tie coat which is a one component silicone system, a two components silicone system or a three components silicone system, applied over and to the synthetic material layer iii;
(v) a silicone fouling release top coat comprising a silicone resin and one, two or more fouling release agents, applied over and to the intermediate silicone tie coat iv; and
(vi) a removable polypropylene film applied over and to the fouling release top coat v.

A side 2 of the silicone fouling release top coat v facing away from the intermediate silicone tie coat iv, is provided with a surface morphology comprising a regular distributed pattern of ribs 3. Adjacent ribs 3 are spaced according to a distance D1. All ribs 3 show the same symmetrical triangular structure ending in sharp tops. A rib 3 is also defined by an opening angle α, a width W and a height H. Tops of adjacent peaks are spaced according to a dimension D2.

According to preferred embodiments, the surface morphology of the silicone fouling release top coat v is realized in three steps I-III, which steps are schematically shown in FIG. 8A. In a first step I, a cylindrical steel rod 4 is provided with an embossing which represents the desired surface morphology of the top coat v, including peaks 5 with identical form as the ribs 3 to be formed. In a second step II, the removable polypropylene film vi is embossed by pressing and rolling said rod 4 against and along the film vi. The resulting embossed removable polypropylene film vi shows a morphology which is a negative from the desired surface morphology of the top coat v, including trapezoidal protrusions 6. In a third step III, the embossed removable polypropylene film vi is laminated onto the side 2 of the silicone fouling release top coat v facing away from intermediate silicone tie coat iv, resulting in the formation of the surface morphology of the silicone fouling release top coat v.

Surface morphology optimization was performed for multilayer self-adhesive fouling release films with textured surface 1 coated on outer surfaces of (fast-going) cruise vessels and a (slow-going) bulker as test cases (Examples 1-4).

The removable underlying liner i of the multilayer self-adhesive fouling release film with textured surface 1 is removed prior to coating of the film with textured surface 1 with its adhesive layer ii on outer surfaces of cruise vessels and a bulker as test cases. The removable polymeric film vi is removed once the film with textured surface 1 has been coated on said outer surfaces. A multilayer self-adhesive fouling release film with textured surface which is coated on one of said outer surfaces is schematically shown in FIG. 3.

Table 1 presents the computation results for the optimal surface morphology for different test cases of cruise vessels and a bulk carrier coated with a film with textured surface according to preferred embodiments of the invention. Table 1 is to be read in conjunction with FIG. 5, which shows the appearance of the surface morphology according to Examples 1-4. For the computation, the cruise vessels and bulk carrier were assumed to be subjected to water flowing under realistic flow conditions, as expressed by the Reynolds number of the flow. The full scale twin-screw passenger vessel has a length of 220 m, a width of 32 m and a draft of 7.2 m. The design speed of the vessel is 22.5 knots, which results in a full scale Reynolds number of 2×10⁹ and a Froude number of 0.249. The Froude number is a dimensionless number defined as the ratio of the flow inertia to the gravity field. In naval architecture, the Froude number is a very significant figure, because the wave pattern generated is similar at the same Froude number only. Reynolds numbers of 9.7×10⁶ and 7×10⁷ were used to mimic test conditions in a tank and a large cavitation tunnel, respectively. The full scale bulk carrier has a length of 182 m, a width of 32 m and a draft of 11 m. The design speed of the vessel is 15 knots, which results in a full scale Reynolds number of 1.2×10⁹ and a Froude number of 0.183. Computations were performed on the basis of a mathematical model that is essentially equal to the Reynolds-averaged Navier-Stokes (RANS) equations, supplemented with a series of turbulence models based on an eddy viscosity concept and a treatment of multi-phase flows using a volume of fluid approach.

TABLE 1
Main computation results for optimal surface
morphology of multilayer self-adhesive fouling
release films with textured surface 1 coated on outer
surfaces of cruise vessels (Examples 1-3) and a bulk
carrier (Example 4) as test cases, according to
preferred embodiments of the invention

| | | Distance | | |
|---|---|---|---|---|
| | | D1 | | |
| | | between | Height | |
| | Reynolds | adjacent | H | Opening |
| | number | ribs 3 | of ribs | angle of |
| | (—) | (μm) | 3 (μm) | ribs 3 (°) |
| Example 1: Computation for | 9.7 × 10⁶ | 295-305 | 145-155 | 28-32 |
| twin-screw passenger vessel | | | | |
| (model scale in tank) | | | | |
| Example 2: Computation for | 7 × 10⁷ | 155-165 | 75-85 | 28-32 |
| twin-screw passenger vessel | | | | |
| (model scale in a large | | | | |
| cavitation tunnel) | | | | |
| Example 3: computation for | 2 × 10⁹ | 60-70 | 27.5-37.5 | 28-32 |
| twin-screw passenger vessel | | | | |
| (full scale) | | | | |
| Example 4: computation for | 1.2 × 10⁹ | 85-95 | 40-50 | 28-32 |
| bulk carrier (full scale) | | | | |

Computation has thus shown that the found optimal height H or ribs 3 is about half of the spacing or distance D1 between adjacent ribs 3. Surface morphologies of the multilayer self-adhesive fouling release films with textured surface coated on the twin-screw passenger vessels and bulk carrier, according to Examples 1-4 and as shown in Table 1 (to be read in conjunction with FIG. 5), have been computed to result in optimal drag reduction. Drag reduction has both environmental and economic advantages, since it results in fuel savings and reduction of greenhouse gas emissions. At the same time, the surface morphologies have been found to effectively impair the adherence of underwater organisms to the fouling release film with textured surface, thus improving fouling release by the film with textured surface and avoiding increased drag in time. Besides, due to its specific multilayered structure, the film with textured surface 1 is environmentally friendly, easy to coat onto a substrate and robust.

Drag reduction of the multilayer self-adhesive fouling release film with textured surface 1 according to preferred embodiments of the invention, while coated to substrates, has been tested and is shown in Examples 5-9 discussed below. Fouling release properties have also been evaluated, as discussed below in Examples 10-12.

For the drag reduction tests (Examples 5-9) plastic tubes of 6 m length and 0.5 m diameter have been fully coated with films with textured surface 1 to be tested. A whole underwater test body had a total length of 7.42 m (including bow and stern adapter), a total surface of 9.42 m² and can be tested to water speed up to 10 m/s (ab. 19.5 kts). The test body is mounted on lower stage of a high precision force balance to measure directly the drag force at different flow speeds. The test body is mainly used to perform comparative frictional resistance measurements of different coatings.

Five different coatings were tested in the drag reduction tests:
1. an epoxy substrate without fouling release performance (Example 5);
2. a standard fouling release sprayed paint (serving as reference) (Example 6);
3. smooth fouling release foil (i.e. equal to the film with textured surface shown in FIG. 3 when applied to the test body, except for the surface morphology with ribs 3 being absent) (Example 7);
4. fouling release film with textured surface 1 according to embodiments of the present invention (FIG. 3) (Example 8); and
5. pyramidal fouling release foil (i.e. film with textured surface 1 according to embodiments of the present invention and when applied to the test body as shown in FIG. 3, except for a different surface morphology which is shown in FIG. 7) (Example 9).

After filling up a tunnel with water and careful de-aeration the water speed was increased within 10 steps up to 10 m/s and decreased in intermediate steps down to zero speed while measuring the total drag force acting on the test body. The whole process of increasing and decreasing water speed had a duration of 2 h. The measurement data during each speed step were averaged.

Detailed analysis of the measurement data resulted in the relative frictional drag of the different samples referenced to the standard fouling release sprayed paint. The smooth foil (Example 7) presents similar frictional drag as the sprayed paint (Example 6), while the pyramidal foil (Example 9) has up to 6% higher values. The fouling release film with textured surface 1 according to Example 8 and the epoxy coating (Example 5) have shown up to 2% drag reduction.

Fouling release performance has been investigated in the North Sea and in the Mediterranean Sea for the following three foil types (Examples 10-12):
1. smooth fouling release foil (i.e. equal to the film with textured surface shown in FIG. 3, except for the surface morphology with ribs 3 being absent) (Example 10)
2. pyramidal fouling release foil (i.e. film with textured surface 1 according to embodiments of the present invention as shown in FIG. 3, except for a different surface morphology which is shown in FIG. 7) (Example 11); and
3. fouling release film with textured surface 1 according to embodiments of the present invention (FIG. 3) (Example 12).

A first fouling release performance test was performed for 6 months in The North Sea at the level of Kats in The Netherlands. A second fouling release performance test was performed for 4 months in the Mediterranean Sea at the level of Sliema in Malta. For Examples 10-12, no soft or hard fouling was detected after completion of said fouling release performance tests.

This shows that the fouling release film with textured surface 1 according to the present invention has excellent fouling release properties and also has improved drag reduction compared with a similar fouling release film without the surface morphology comprising ribs 3.

### Examples 13-14

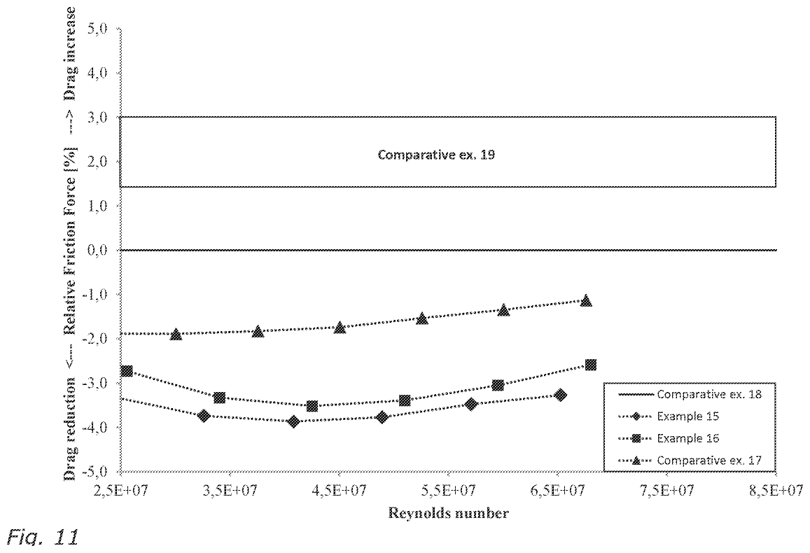

FIGS. 9 and 10 show schematic representations of adjacent application of multilayer self-adhesive fouling release films with textured surface 1, 1′, 1″ on a substrate 7, according to embodiments of the present invention. FIG. 9 shows an application of adjacent films with textured surface 1, 1′, 1″ along a flow direction Y of water (Example 13). FIG. 10 shows an application of adjacent films with textured surface 1, 1′, 1″ perpendicular to a flow direction Y of water (Example 14). To acquire a good sealing between the adjacent films with textured surface 1, 1′ 1″, a suitable edge sealant fouling release coating composition 8, e.g. as described in EP3330326A1, can be applied in between.

Ribs 3, 3′, 3″ of each of the films with textured surface 1, 1′, 1″ are also shown in FIGS. 9-10. Detailed views of sections along an axis X-X show that the adjacent application perpendicular to the flow direction Y results in a misalignment of ribs 3, 3′, 3″, and that the edge sealant composition 8 forms a transverse barrier to flow closing channels formed by the ribs 3, 3′, 3″ at least partly. Both effects are expected to have a deleterious effect on drag reduction performance of the films with textured surface 1, 1′, 1″. Therefore, the investigators have found that an adjacent application along the flow direction Y of water is to be preferred.

### Examples 15-16 and Comparative Examples 17-19

The surface morphology has been optimized for drag reduction for two specific ship designs, a cruise vessel and a bulk carrier. The drag reduction has then been investigated in the North Sea and in the Mediterranean Sea for the following foil types:
A multilayer self-adhesive fouling release film with textured surface according to the present invention, wherein the surface morphology is optimized for a cruise vessel (Example 15).
A multilayer self-adhesive fouling release film with textured surface according to the present invention, wherein the surface morphology is optimized for a bulk carrier (Example 16).
A commercially available smooth fouling release foil according to WO2016/120255 as comparative example (Comparative example 17).
A commercially available fouling release spray paint (Comparative example 18).

FIG. 11 shows a summary of all drag reduction tests performed on examples 15-16 and comparative examples 17-18. FIG. 11 also shows a range applicable for comparative experimental data of state of the art antifouling coatings (Comparative example 19).

Hydrodynamic tests have proven the foil performance in respect to drag reduction, foil strength, adhesive performance and application procedure up to near-operational conditions of 20 kts. The results for friction drag reduction of the multilayer self-adhesive fouling release film with textured surface ranges from 3% to 4% compared to standard fouling release paint and 5% to 7% compared to antifouling coatings.

Today's vessels of the international shipping are mainly equipped with antifouling (estimated about 96%) and to a much lesser extent fouling release (estimated about 2%). Based on these and the friction drag reduction experiments, a conservative assumption of 5% for the average skin friction drag reduction is estimated. This 5% average skin friction drag reduction is used for the evaluation of the impact of the present invention in terms of fuel savings, operational costs and CO₂ emissions.

The evaluation of changes in fuel savings, operational costs and CO₂ emissions has been done to illustrate the environmental and the economic benefits of the multilayer self-adhesive fouling release film according to the present invention. The evaluation has been calculated of examples 15 and 16, a cruise vessel and a bulk carrier, with full multilayer self-adhesive fouling release film with textured surface. The results showed a reduction in the total ship resistance of 3.3% and 3.5% respectively resulting in annual savings of 1,284 tons and 490 tons of HFO fuel respectively. This translates to annual operation costs savings of 449,262 USD and 171,634 USD respectively and in annual reduction of greenhouse gas emissions (CO₂) of 3,997 tons and 1,527 tons respectively.

### Examples 20-21

For optimization of hull bow designs, the surface morphology of the silicone fouling release top coat v may be adapted. The ribs are comprised of a series of discrete, aligned protrusions. This surface texture is realized in three steps I-III, which steps are schematically shown in FIG. 8B (example 20) or FIG. 8C (example 21). In a first step I, a cylindrical steel rod 4 is provided with an embossing which represents the desired surface morphology of the top coat v, including peaks 5′ with identical form as the protrusions 3′ to be formed. In a second step II, the removable polypropylene film vi is embossed by pressing and rolling said rod 4 against and along the film vi. The resulting embossed removable polypropylene film vi shows a morphology which is a negative from the desired surface morphology of the top coat v, including a series of aligned discrete protrusions 6′. In a third step III, the embossed removable polypropylene film vi is laminated onto the side 2 of the silicone fouling release top coat v facing away from intermediate silicone tie coat iv, resulting in the formation of the surface morphology of the silicone fouling release top coat v.

1. A multilayer self-adhesive fouling release film with textured surface (1) comprising:
(i) an optional removable underlying liner;
(ii) an adhesive layer, applied over and to the optional underlying liner (i) when present;
(iii) a synthetic material layer applied over and to the adhesive layer (ii);
(iv) optionally, an intermediate silicone tie coat which is a one component silicone system, a two components silicone system or a three components silicone system, applied over and to the synthetic material layer (iii);
(v) a silicone fouling release top coat comprising a silicone resin and one, two or more fouling release agents, applied over and to the synthetic material layer (iii), or, when present, over and to the intermediate silicone tie coat (iv); and optionally
(vi) a removable polymeric film applied over and to the fouling release top coat (v),
characterized in that a side (2) of the silicone fouling release top coat (v) facing away from the synthetic material layer (iii), or, when present, facing away from the intermediate silicone tie coat (iv), is provided with a surface morphology comprising a regular or randomly distributed pattern of ribs (3).

2. Film with textured surface (1) according to claim 1, wherein a rib 3 has a height (H) and wherein adjacent ribs (3) are spaced from another according to a distance (D1), and wherein the ratio of the distance (D1) between adjacent ribs (3) and said rib height (H) is from 3:1 to 1:1.

3. Film with textured surface (1) according to claim 2, wherein a rib (3) has a width (W) and wherein rib width (W) and rib height (H) relate according to a ratio from 1:200 to 2:1.

4. Film with textured surface (1) according to claim 2, wherein the height (H) of a rib (3) is from 20 to 200 μm.

5. Film with textured surface (1) according to claim 3, wherein the width (W) of a rib (3) is from 1 to 40 μm.

6. Film with textured surface (1) according to claim 2, wherein the distance between adjacent ribs is from 50 to 400 μm.

7. Film with textured surface (1) according to claim 1, wherein each rib (5) shows an opening angle (α) of 15 to 45°.

8. Film with a textured surface (1) according to claim 1, wherein at least one rib is discontinuous (5′).

9. A method for producing a multilayer self-adhesive fouling release film with textured surface (1), comprising the steps of:
a) providing an adhesive layer (ii) and, optionally, coating a removable underlying liner (i) with the adhesive layer (ii);
b) coating the adhesive layer (ii) with a synthetic material layer (iii);
c) optionally, coating the synthetic material layer (iii) with an intermediate silicone tie coat (iv) which is a one component silicone system, a two components silicone system or a three components silicone system; and
d) coating the synthetic material layer (iii), or, when present, the intermediate silicone tie coat (iv) with a silicone fouling release top coat (v) comprising a silicone resin and one, two or more fouling release agents,
characterized in that at a semi-cured stage of the top coat (v), a removable polymeric film (vi) comprising an embossed surface is laminated onto a side (2) of the silicone fouling release top coat (v) facing away from the synthetic material layer (iii), or, when present, facing away from the intermediate silicone tie coat (iv), wherein said embossed surface of the removable polymeric film (vi) is a negative of a desired surface morphology of the top coat (v) comprising a regular or randomly distributed pattern of ribs (3).

10. Method according to claim 9, wherein said removable polymeric film (vi) is a polypropylene or polyester film.

11. Method according to claim 9, wherein prior to laminating onto said side (2) of the silicone fouling release top coat (v), embossing of the removable polymeric film (vi) resulting in said embossed surface is performed by a textured rod which is pressed against the film (vi).

12. Method according to claim 9, wherein during embossing of the removable polymeric film (vi), said textured rod is pressed against the film (vi) at an embossing pressure from 4 to 8 MPa.

13. Method according to claim 11, wherein said textured rod has a cylindrical shape.

14. Use of a method according to claim 9 for the production of a multilayer self-adhesive fouling release film with textured surface (1) according to any of claims 1 to 8.

15. A method for producing a coated substrate, comprising the step of coating at least part of an outer surface of the substrate with a multilayer self-adhesive fouling release film with textured surface (1) according to claim 1.

16. Method according to claim 15, wherein the film with textured surface (1) and/or the substrate are heated prior to and/or during the coating step.
